(19) United States
(12) Patent Application Publication
(10) Pub. No.: US 2009/0030712 A1
(43) Pub. Date: Jan. 29, 2009

(54) System and method for transferring electrical power between grid and vehicle

(75) Inventors: Bradley D. Bogolea, Beaver, PA (US); Patrick J. Boyle, Dallas, PA (US)

Correspondence Address: WINSTON & STRAWN LLP;PATENT DEPARTMENT, 1700 K STREET, N.W., WASHINGTON, DC, 20006, US

(73) Assignees: Bradley D. Bogolea; Patrick J. Boyle

(21) Appl. No.: 11/878,714

(22) Filed: Jul. 26, 2007

(51) Int. Cl. G06Q 50/00; B60K 1/00; G08G 1/123; H02J 7/00

(52) U.S. Cl. 705/1; 180/65.1; 320/109; 340/988; 903/903; 903/907; 903/908

(57) ABSTRACT

The present invention discloses a system for transferring electrical power between a grid and at least one vehicle. The vehicle can be Battery Electric Vehicle (BEV), Plug-in Hybrid Electric Vehicle (PHEV) or Fuel Cell Vehicle (FCV). The type of vehicle will be recognized and controlled by the system to support demand response and supply side energy management. Vehicle recognition can be carried out by load signature analysis, power factor measurement or RFID techniques. In an embodiment of the invention, the grid is a Smart Grid. The present invention also discloses a method for facilitating electrical power transfer between the grid and the vehicle.

### BACKGROUND OF THE INVENTION

Battery electric vehicles (BEVs), Plug-In Hybrid Electric Vehicles (PHEVs), and Fuel Cell Vehicles (FCVS) can provide many positive functions to the electrical utility grid and its customers.

The most basic example involves net metering, in which electricity can flow both directions in a residence, and the customer is billed only for the net electricity consumed during the billing period. In this case, vehicles can be programmed to push electricity back onto the electrical grid to help reduce the total electricity consumed in the residence.

This has several flaws since the vehicles are not 100% efficient, and the cost to recharge the vehicle in a static pricing scheme would outweigh the savings from pushing it back onto the grid.

This leads to a more advanced scenario, wherein the vehicles push electricity on the grid in variable pricing areas only when the money earned will be more than the cost to recharge the battery, as well as pay for the battery's reduced lifetime and inconvenience to the user.

BEVs will use the storage in their batteries to push power onto the grid, and will need to pull power from the grid to recharge. Since the batteries charge primarily from the grid (some have solar or regenerative means while driving), when their batteries run out, they can no longer support distributed generation.

PHEVs and FCVs can keep providing power as long as it is economical for the customer to do so. PHEVs have a secondary fuel source, which can be gas, natural gas, etc., as go FCVs, and several systems have been disclosed which utilize the natural gas mains in the home to perpetually provide fuel to generate electricity from the vehicle. This is useful, but care must be taken to insure that the payments exceed the cost of electricity to recharge batteries or fuel to replace that used in the generation process, as well as wear-and-tear on the generator in the car.

Another source of prospective value is energy quality regulation. Utilities try to maintain a very low Area Control Error (ACE), which in turn ensures a clean 60 Hz AC signal in the electricity available fro the grid. The batteries in BEVs, PHEVs, and FCVs could significantly increase the quality of power near end points on the grid, specifically residences, communities, and businesses. Power regulation is 0 net energy, since energy absorbed generally equals energy pushed in keeping the available power at a steady 60 Hz sine wave. This does not require extra fuel to be consumed, does not drain batteries, and will cause only minimal strain on the batteries while the service is being performed.

The area with perhaps the most value is preventing or helping the utility recover from brownouts/blackouts. The energy storage and/or generating capacity available in BEVs, PHEVs, and FCVs can assist in providing peak energy when the customer demand is approaching the utility supply. Instead of purchasing expensive power from a neighboring utility or running out of available power, the utility could tap into the energy from vehicles. This scenario typically happens only for a short duration only a few times a year, and the money earned from providing power to the grid would surely exceed the costs for the customer to provide it. If the customer is not in an area where the utility directly pays for and controls the energy generated during these super peak periods, the customer can still save money and help the situation by using the vehicle to provide household power and still push some back onto the grid to assist in the shortage.

In the event of a blackout, the vehicle should not try to re-energize the grid by itself, because it probably cannot and may damage household wiring, the electric meter, or the car's electrical system. Also, in the case of an emergency, the vehicle needs to be available to drive a substantial distance should people need it for transportation.

### BRIEF SUMMARY OF THE INVENTION

The present invention is a system for controlling BEVs, PHEVs, and FCVs while plugged into the electric grid to provide the amalgam of useful functions to the customer and electric utility, including the following:
1. Price-sensitive recharging and discharging so batteries recharge when costs are below a certain cost, and discharge when they are above a certain higher cost (in the case of a PHEV or FCV with a fuel source in the location where it is connected to the grid, power can be provided continuously to ensure a total number of kWh are not exceeded during a specific period of time)
2. Energy quality regulation during the entire period in which the vehicle is connected to the power grid
3. Super-peak power discharging to help decrease the danger of a brownout/blackout event
4. Grid recovery assistance or home power generation in the event of a brownout/blackout

The controls for such a system will ideally come from the electric utility. This way, compensation can be given for vehicles during the times they are regulating power. Also, the utility is in the best position or organize and optimize the mitigation of brownout and blackouts by cycling the available vehicles similar to air-conditioner cycling in areas with load shedding to reduce peak demand. This way the available power is not all used up after a few short hours if there is still a shortage on the grid.

If the utility does not support or implement some type of control method, the disclosed system can still benefit the customer. The system can be programmed to discharge the batteries when the cost of electricity is high enough to generate profits, recharge when it is cheapest, and regulate the power inside the home to help protect the loads within. A configurable minimum amount of charge will be maintained at all times to ensure that the vehicle is available to be driven where it needs to go. In the case of PHEVs or FCVs, the generative means will be utilized if the price of electricity is higher than the cost of replacement fuel for the generator or fuel cell. If net metering is not available, the home can simple be powered partially or fully by the car's generative means or battery during high-price periods so the residents are not paying the utility peak prices for electricity.

The system is made up of the following:
1. A bi-directional outlet-type interface, including measurement and monitoring of at least power in, power out, voltage, frequency, power factor (will use these measuring means to identify a power-related emergency such as a brownout/blackout.
2. A relay, breaker, or switch that is locally or remotely controlled to allow the outlet to disconnect the vehicle from the grid in the case of a power outage or other emergency (may be internal or external to the bi-directional outlet)
3. A communications means, which may be one or more of the following: communication over power line (COPL), Bluetooth, 802.15.4/ZigBee, cellular wireless, IP computer network, used to establish communications with the utility directly, the utility meter, one or more BEVs/PHEVs/FCVs, and/or computers, PDAs, or other electronics devices.
4. Absolute location means, which may be determined using GPS or extrapolated using a relative location means with respect to a known location such as the electric utility meter or outlet used to connect the vehicle to the grid.
5. In the case of a PHEV or FCV, a fuel line which connects to the natural gas or other fuel source to expand the producing capacity of the vehicle

The bi-directional outlet will have a means for connecting with the household electrical wiring, whether it is hardwired or connects through a standard 110 V/220 V wall outlet. It will also have a receiving means for accepting an electrical connection to the vehicle, which may be in the form of a standard 100 V/220 V plug. The outlet will determine which vehicle is plugged into it by one or more of the following methods: load signature analysis (by power factor, current draw, harmonics, combination or other method, electronic communications with the vehicle, etc.

### Communications Information

The information shared by utilities and accessed by the system either directly or through the utility meter may include a plurality of information, which may include:
1. Pricing information, both current and forecasted
2. Energy supply information, including conservation or power generation requests
3. Individual commands to control the battery/generative means/fuel cell inside a vehicle to push power onto the grid or recharge batteries from the grid
4. Notification that there is an upcoming or currently is a power emergency or failure

The more control and information the utility exerts and provides, the more effectively the grid is utilized. Cycling charging among a large group of cars ensures that a steady load is present during the night and other popular recharging times so the grid is not overwhelmed. Draining the batteries in a similar manner will allow the utilities to ensure a longer time period during which vehicle power is available, so as not to completely drain the available sources of emergency peak power.

The information collected by the utility or other entity which controls the system may include, but is not limited to:
1. Vehicle type, including battery capacity, generator/fuel cell size, and available fuel/charge
2. Whether or not the vehicle is in a mode which will allow energy regulation, electricity generation, or charging
3. Location, obtained through absolute means such as GPS or with reference to a known location, such as the utility meter or bidirectional outlet.

The system serves as a mediator between the utility, energy aggregator, home, and/or vehicle because each may be using a different set of monitoring, control, and communications protocols to communicate, including BACnet, LONworks, OpenWAY, etc. With updated communications profiles, the system will be able to mitigate the commands and transactions between any utility, home system, vehicle, and energy aggregator. This way there is no setup required for the system to work. Any vehicle can be used in any outlet, and the owner receives the benefits from his or her vehicle.

Knowing the vehicle type and power plant information allows the utility or aggregator to selectively allow charging/generation to maximize effectiveness of its load limiting and power reliability programs. The utility may allow regulation during all hours, or only during times when ACE is outside the desired range specified by the utility.

The mode that the vehicle is in is important because utility or utility-sponsored charging and generation control programs will only be accepted if there is a way to opt out in situations when charging is needed immediately or a full charge (or tank of gas) is desired by the customer. Also, the vehicle or outlet is then able to keep track of customer settings, and the utility is saved a lot of data retrieval and processing.

The effectiveness of distributed regulation, regulation, and load limiting is generally only effective in the local region of the distributed equipment. Allowing each vehicle to be identified by location is important in knowing which utilities or companies are receiving the benefit and who will receive compensation for the vehicle's services. Using a relative means for location is preferred because GPS does not generally work indoors or underground, where many cars are parked a majority of the time, and therefore are the locations where they are likely to be connected to the grid.

Recovering from Brownouts/Blackouts

The disclosed system will buffer the home and vehicle from the grid in the event of a severe brownout or blackout, allowing the home to receive electricity from the vehicle to provide power. Utilities with smart meters can assist with recovering from energy emergencies by using the battery-powered AMI meters to block electrical flow to homes affected by the brownout/blackout in order to lower the amount of load on the grid. Residences and locations with EVs, PHEVs, and FCVs can then be brought back on the grid to help increase the available power, and then homes without generation means can be brought back online without fear of sending the grid back into chaos by turning on all residences at the same time.

In this scenario, the disclosed system protects the vehicle(s) in an individual residence by separating them from the problems on the grid. This protects the household electronics and the vehicle. Most inverters will shut off when the electrical signal it is trying to match is altered or lost, but the ability for vehicles to help recover from the problem is lost in this case. Separating the vehicle from the grid until it is safe to allow it to help power back on the local grid is both an efficient and rapid response to help get power back to the utility customers.

If there is not a means to communicate with the utility or energy aggregator, the system will simply separate the home from the grid during the power failure and power itself directly from the vehicle's power plant.

### BRIEF DESCRIPTION OF THE DRAWINGS

FIG. 1 shows a block diagram of the user module, as an embodiment of the present invention.

FIG. 2 shows operation of the system for transferring electrical power from grid to vehicle and vehicle to grid, as an embodiment of the invention.

FIG. 3 shows the normal operating state of the system for a Battery Electric Vehicle (BEV), as an embodiment of the invention.

FIG. 4 shows the normal operating state of the system for a Plug-in Hybrid Electric Vehicle (PHEV) or a Fuel Cell Vehicle (FCV), as an embodiment of the invention.

FIG. 5 shows the emergency operating state of the system as an embodiment of the present invention.

### DETAILED DESCRIPTION OF THE INVENTION

The present invention discloses a system for transferring electrical power between a grid and at least one vehicle. The system further provides an electrical isolation between the vehicle, the grid and a building in case of a brownout or a blackout event. The system also facilitates in providing electrical power to the building from the vehicle. In one embodiment of the invention, at least one battery is used as the means for storing electrical power in the vehicle. However, other electrical power storage devices can also be used, without limiting the scope of the invention.

The system comprises of a user module connected to the grid and to the vehicle via a communication network. The user module is further connected to a fuel source. The communication network comprises of Communication Over Power Line (COPL), Bluetooth, IEEE 802.15.4, ZigBee, cellular wireless network or IP based computer network. The communication network uses protocols such as, for example, BACnet, LonWorks, OpenWay, OpenAMI, SmartGrid, ZigBee or AMI profile. However, as might be apparent to a person skilled in the art, communication networks and protocols other than those mentioned here can also be used, without limiting the scope of the present invention.

The user module is further capable of establishing direct communication with a utility meter, computer or a remote communication device such as, for example, a personal digital assistant (PDA). The user module is also capable of exchanging information with at least one utility company. Such information may include, cost of electrical power, energy supply information, status information and user notifications. The cost of electrical power includes both, the current cost and the forecasted cost of electrical power. Energy supply information includes energy conservation requests and electrical power generation requests for the user. Status information comprises of power generation status and power charging/discharging status of the vehicle battery. User notifications inform the user if there is an upcoming power emergency or failure. It might be apparent to the person skilled in the art that such information exchanged between the user module, utility company and the vehicle is directed to enhance the utilization of the grid, and any modifications in this regards must not be viewed as a limitation to the scope of the invention.

Further, the utility company can also collect control information from the user and the vehicle via the user module. The control information includes, but is not limited to, type of the vehicle, battery capacity of the vehicle, generator size, fuel cell size, available fuel, available charge and operating mode of the vehicle. Electrical power transfer can be further controlled by checking whether the vehicle is in a mode for electrical power regulation or electrical power generation, as the operating mode. In one embodiment, the utility company allows electrical power regulation for the entire time period during which the vehicle is connected to the grid. In another embodiment, electrical power regulation is provided only for a definite time period. The definite time period is set by the utility company. In yet another embodiment, electrical power regulation is provided depending upon the Area Control Error (ACE). A low ACE value ensures a clean 60 Hz AC signal in the electrical power available from the grid. Utilities thus try to maintain a very low ACE value. In one embodiment, electrical power regulation is provided when the ACE exceeds a predefined range set by the user. In another embodiment, the predefined range for ACE is set by the utility company.

For transferring electrical power from a grid to vehicle and vehicle to grid, it is useful to know the absolute geographical location of the vehicle. The absolute geographical location of the vehicle helps in determining which utility is involved in the transfer of electrical power. Further, the user can be compensated by the utility company for providing electrical power to the grid. Knowing the absolute geographical location of the vehicle helps the utility company in identifying which user needs to be compensated. The user module is capable of identifying the absolute geographical location of the vehicle. In an embodiment of the invention, GPS technology is used to identify the absolute geographical location of the vehicle. In another embodiment, the absolute geographical location of the vehicle is determined by extrapolating a relative geographical location with respect to a known geographical location. The known geographical location can further be determined by use of a utility meter. Using the extrapolation means to determine the absolute geographical location of the vehicle is more useful when majority of the vehicles are parked most of the time or when the vehicle is located underground.

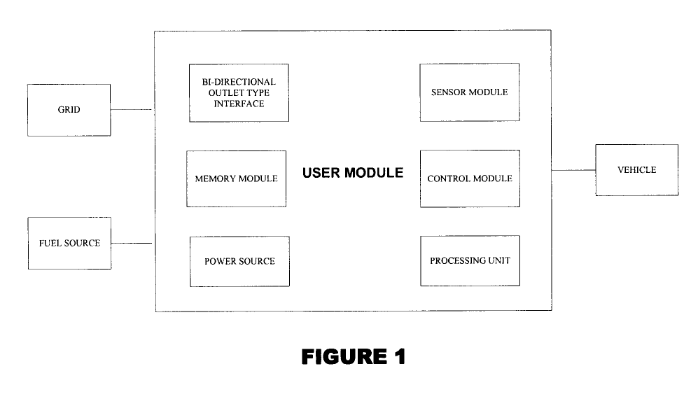

FIG. 1 shows the block diagram of the user module, as an embodiment of the invention. The user module comprises of a bi-directional outlet type electrical interface. The bi-directional outlet type electrical interface monitors parameters such as, for example, power in, power out, voltage, frequency and power factor. These parameters can further be used to identify brownout and blackout events.

The bi-directional outlet type electrical interface is connected to a switch. The switch can be a relay or a circuit-breaker. The switch is used to electrically isolate the vehicle from the grid, in case of a power outage, a brownout or a blackout event. Further, the switch also electrically isolates the building from the grid, in case of a power outage, a brownout or a blackout event. In one embodiment of the invention, the switch is integrated into a utility meter. In another embodiment, the switch is integrated into the bi-directional outlet type electrical interface. Further, the switch can either be locally controlled or it may be remotely controlled by the bi-directional outlet type electrical interface.

The bi-directional outlet type electrical interface is capable of connecting to the electrical wiring of a building. In one embodiment, the connection between the bi-directional outlet type electrical interface and the electrical wiring of the building is hardwired. In another embodiment, the connection between the bi-directional outlet type electrical interface and the electrical wiring of the building is through a standard 110 V/220 V outlet.

The bi-directional outlet type electrical interface is further capable of receiving an electrical connection from the vehicle. In one embodiment, the electrical connection from the vehicle is received through a standard 110 V/220 V outlet.

The type of vehicle can be determined by the bi-directional outlet type electrical interface. For determining vehicle type, approaches such as for example, load signature analysis, power factor measurement or RFID can be used. In case of load signature analysis, the information obtained by the bi-directional outlet type electrical interface can be entered into a load signature database or a neural network. Load signature analysis further comprises of power factor analysis, current draw and harmonic analysis. It might be apparent to the person skilled in the art, that approaches other than those described here can also be used for determining type of the vehicle, without in any way limiting the scope of the present invention.

The user module further comprises of a processing unit, a memory module, a sensor module, a control module and a power source. The processing unit includes a control logic. The control logic controls various functions for transferring electrical power between the grid and the vehicle, such as, for example, controlling the electrical power supply to the vehicle, electrical power regulation and controlling the acquisition of electrical power from the vehicle. The step of supplying electrical power to the vehicle further comprises of charging a battery of the vehicle. The step of acquiring electrical power from the vehicle further comprises of discharging the battery of the vehicle. As might be apparent to the person skilled in the art, the battery is simply used as a means for storage of electrical power and must not be considered as a limitation to the scope of the invention. Further, in case of Plug-in Hybrid Electric Vehicle (PHEV) and Fuel Cell Vehicle (FCV), electrical power can be supplied by an external fuel. In one embodiment of the invention, natural gas is used as the external fuel. However, fuels other than natural gas can also be used, without affecting the scope of the invention.

The system is further capable of charging and discharging the vehicle battery in a price-sensitive manner. In this case, the vehicle battery is charged when the cost of electrical power is below a certain predefined level. Electrical power is acquired from the vehicle by discharging the vehicle battery when the cost of electrical power is above a certain predefined level. The predefined level can be set by either the user or the utility company. Further, in case of a Plug-in Hybrid Electric Vehicle (PHEV) or a Fuel Cell Vehicle (FCV), the vehicle battery can be charged and discharged to ensure that a definite number of kWh are available to the grid for a specified time period. The definite number of kWh can be selected by the utility company. In one embodiment, the specified time period is chosen as the peak electrical power usage period. In this way, the probability of occurrence of a brownout or a blackout event can be reduced. The user can further be compensated by the utility company, for providing electrical power from the vehicle for the definite time period.

In order to avoid overloading the grid, the system is further capable of charging and discharging the vehicle in a cyclic manner. In this case, a group of vehicles are charged in a cyclic manner to ensure that a steady load is present during the night and other popular charging times. Discharging the vehicle battery in a cyclic manner ensures that the vehicles are able to supply electrical power for a longer time period, thus helping the utility company in periods of peak electrical power usage.

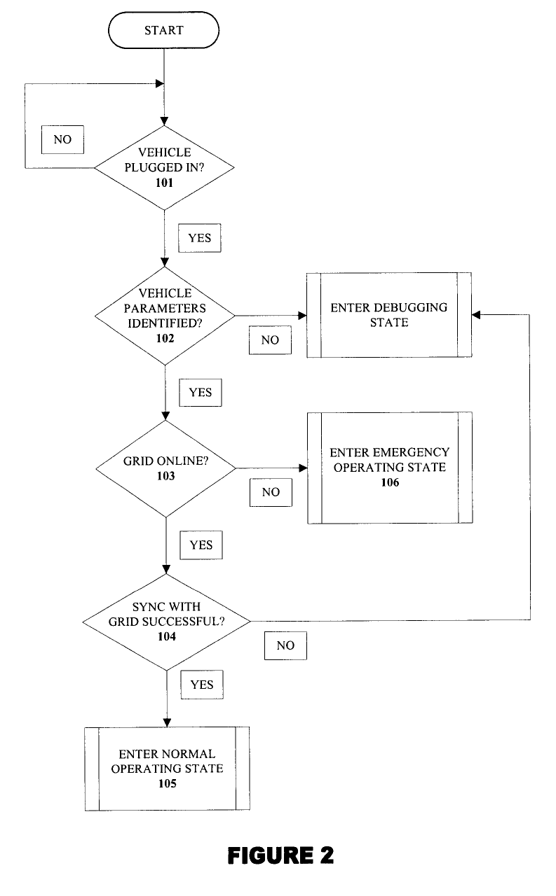

FIG. 2 shows operation of the system for transferring electrical power from grid to vehicle and vehicle to grid, as an embodiment of the present invention. At step 101, the system detects whether the vehicle is plugged into the user module. At step 102, the vehicle parameters are identified. The vehicle parameters comprise of type of vehicle, absolute geographical location of the vehicle and amount of electrical power stored in the vehicle. Several parameters other than those mentioned here can also be identified, without limiting the scope of the present invention. At step 103, the system detects whether the grid is online. If the grid is not online, then the system enters into the emergency operating state at step 106. At step 104, the system tries to synchronize with the grid and checks whether the synchronization to the grid was successful. At step 105, the system enters into the normal operating state. If step either 102 or 104 fails, then the system enters the debugging state.

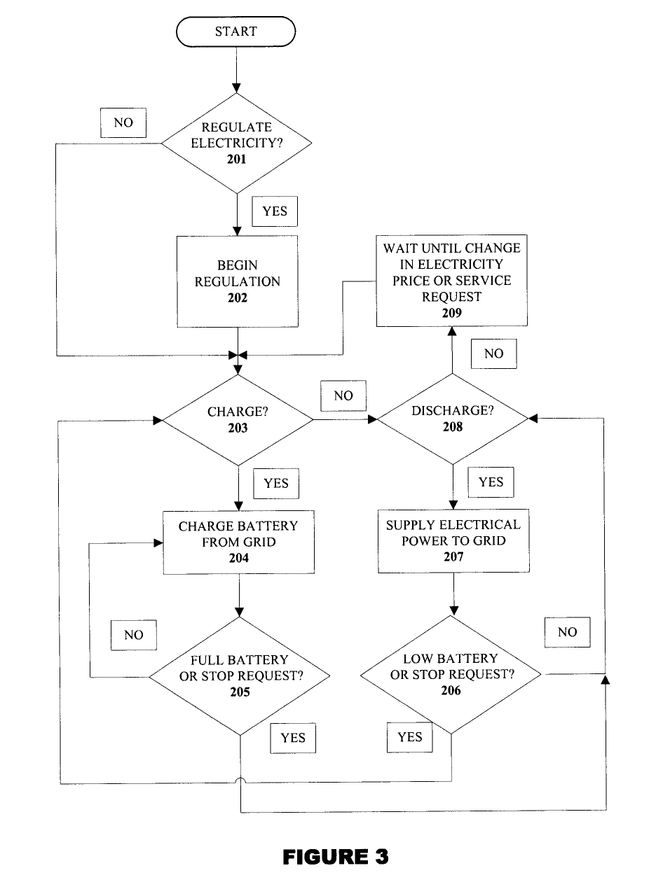

FIG. 3 shows the normal operating state of the system for a Battery Electric Vehicle (BEV), as an embodiment of the present invention. At step 201, the system checks whether the vehicle requires regulation of electrical power. This is determined using the current price of electrical power or a service request from the user. At step 202, regulation of electrical power is begun by the system. At step 203, the system determines whether the battery of the BEV requires charging. If the battery requires charging, the system proceeds to step 204, wherein the vehicle battery is charged using electrical power from the grid. At step 205, the system either detects a fully charged battery or a stop request from the user. When electrical power is acquired from the vehicle, the system proceeds to step 208, wherein the vehicle battery is discharged. At step 207, the vehicle supplies electrical power to the grid. When the system detects a low battery or a stop request from the user at step 206, the system re-enters step 203 and starts charging the vehicle battery again.

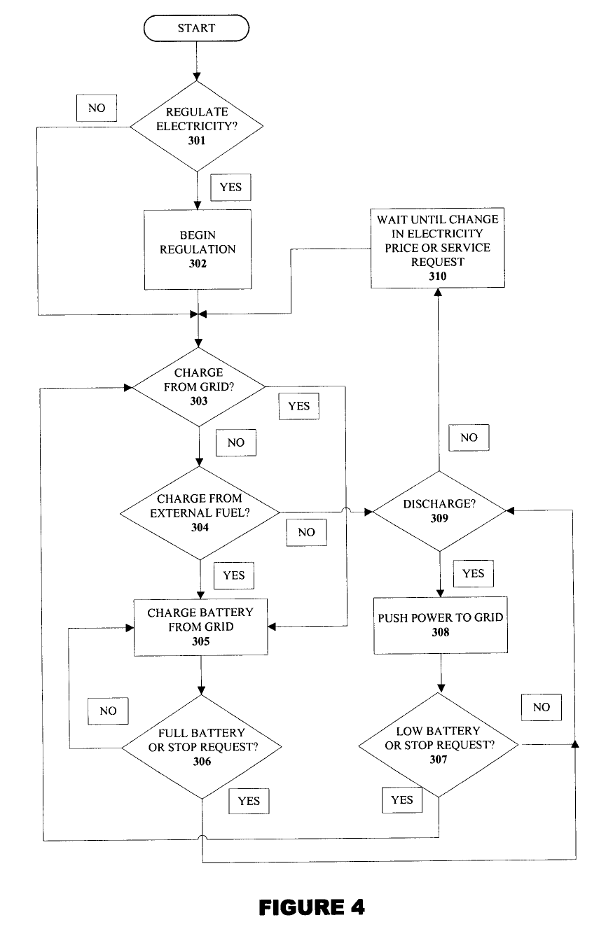

FIG. 4 shows the normal operating state of the system for a Plug-in Hybrid Electric Vehicle (PHEV) or a Fuel Cell Vehicle (FCV), as an embodiment of the invention. At step 301, the system checks whether the vehicle requires regulation of electrical power. This is determined using the current price of electrical power or a service request from the user. At step 302, regulation of electrical power is begun by the system. At step 303, the system determines whether the battery of the PHEV or FCV requires charging. If the battery requires charging, the system proceeds to step 305, wherein the vehicle battery is charged using electrical power from the grid. If it is not possible to charge the battery of the vehicle from the grid, then the system proceeds to step 304. At step 304, it is checked whether the vehicle battery can be charged using an external fuel source. In one embodiment of the invention, natural gas is used as the external fuel source. At step 306, the system either detects a fully charged battery or a stop request from the user. When electrical power is acquired from the vehicle, the system proceeds to step 309, wherein the vehicle battery is discharged. At step 308, the vehicle supplies electrical power to the grid. When the system detects a low battery or a stop request from the user at step 307, the system re-enters step 303 and starts charging the vehicle battery again.

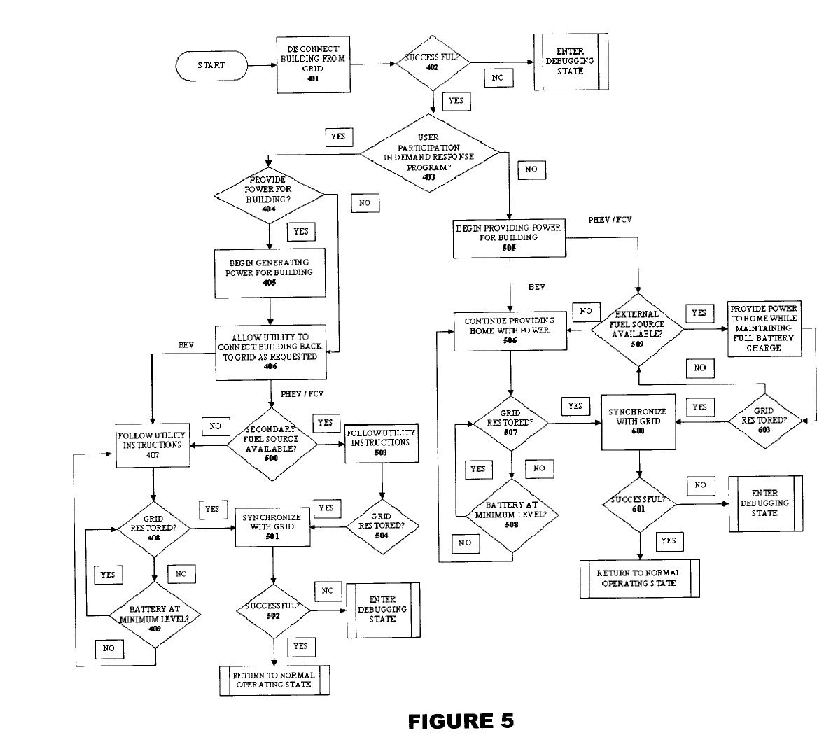

FIG. 5 shows the emergency operating state of the system. At step 401, the system disconnects the building from the grid. This may accomplished by using a switch connected to the bi-directional outlet type electrical interface. At step 402, the system detects whether the building has been successfully disconnected from the grid. Then at step 403, the system checks the participation of the user in the demand response program. Upon participation of the user, the system proceeds to step 404, wherein electrical power is provided to the building. At step 405, the system issues a command to start the generation of electrical power for the building. Then at step 406, the system allows the utility to connect the building back to the grid, as requested by the user. At step 407, the Battery Electric Vehicle (BEV) starts following instructions issued by the utility company. At step 408, the system checks whether the grid is restored. If the grid is restored, the system jumps to step 501, wherein synchronization with the grid is achieved. After detecting successful synchronization with the grid at step 502, the system returns to the normal operating state. If the grid is not restored, then the system checks whether the battery of the BEV is at a minimum configurable level, at step 409. If the vehicle is a Plug-in Hybrid Electric Vehicle (PHEV) or a Fuel Cell Vehicle (FCV), the system proceeds to step 500, wherein the availability of an external fuel source is detected. If an external fuel source is available, the system proceeds to step 503 wherein instructions issued by the utility company are followed. At step 504, the system detects whether the grid is restored. If the grid is restored, the system jumps to step 501, wherein synchronization with the grid is achieved. After detecting successful synchronization with the grid at step 502, the system returns to the normal operating state. If an unsuccessful synchronization with the grid is detected at step 502, the system enters into the debugging mode.

At step 403, if the participation of the user is not detected, the system proceeds to step 505, wherein electrical power is provided to the building. At step 506, the Battery Electric Vehicle (BEV) continues providing power to the building. At step 507, the system checks whether the grid is restored. If the grid is restored, the system jumps to step 600, wherein synchronization with the grid is achieved. After detecting successful synchronization with the grid at step 601, the system returns to the normal operating state. If the grid is not restored, then the system checks whether the battery of the BEV is at a minimum configurable level, at step 508. If the vehicle is a Plug-in Hybrid Electric Vehicle (PHEV) or a Fuel Cell Vehicle (FCV), the system proceeds to step 509, wherein the availability of an external fuel source is detected. If an external fuel source is available, the system proceeds to step 602 wherein the system provides electrical power to the home while maintaining a full battery charge. At step 603, the system detects whether the grid is restored. If the grid is restored, the system jumps to step 600, wherein synchronization with the grid is achieved. After detecting successful synchronization with the grid at step 601, the system returns to the normal operating state. If an unsuccessful synchronization with the grid is detected at step 601, the system enters into the debugging mode.

The control logic is further capable of entering into an idling mode, wherein no control function is performed by the system. The system enters into a debugging mode whenever an error is encountered in the normal or emergency operating states. The error further includes loss of the grid, wherein it is not possible to charge or discharge the battery of the vehicle.

In one embodiment of the invention, the control logic is integrated into the processing unit. In another embodiment of the invention, the control logic is located external to the processing unit.

If the utility company does not support control functions, the control logic can still be programmed to acquire electrical power from the vehicle in case of brownout or blackout events. Further, the control logic can also acquire electrical power from the vehicle when the cost of acquiring electrical power from the vehicle is less than the cost of acquiring electrical power from the grid. To determine the cost of acquiring electrical power from the vehicle, the control logic calculates the cost of supplying electrical power to the vehicle and the fatigue cost of the components involved in the process of electrical power supply and acquisition. In case of Plug-in Hybrid Electric Vehicle (PHEV) or Fuel Cell Vehicle (FCV), the control logic considers the cost of using an external fuel to supply electrical power to the vehicle.

Further, the system maintains a configurable minimum level of charge in the Battery Electric Vehicle (BEV) to ensure that the vehicle can be driven by the user if required. In case of Plug-in Hybrid Electric Vehicle (PHEV) or Fuel Cell Vehicle (FCV), a configurable minimum level of external fuel is maintained in the vehicle by the system.

Numerous variations and modifications within the spirit of the present invention will of course occur to those of ordinary skill in the art in view of the embodiments that have now been disclosed. However, these variations and modifications should not be considered as a limiting factor to the scope of the present invention.

We claim:

1. A system for transferring electrical power between a grid and at least one vehicle, the system comprising:
(a) a user module and
(b) a communication network connecting the user module to the grid and to the vehicle.

2. The system of claim 1, wherein the grid is a Smart Grid.

3. The system of claim 1, wherein the vehicle is a Battery Electric Vehicle (BEV).

4. The system of claim 1, wherein the vehicle is a Plug-in Hybrid Electric Vehicle (PHEV).

5. The system of claim 1, wherein the vehicle is a Fuel Cell Vehicle (FCV).

6. The system of claim 1, wherein the communication network comprises of Communication Over Power Line (COPL), Bluetooth, IEEE 802.15.4, ZigBee, cellular wireless network or IP based computer network.

7. The system of claim 6, wherein the communication network uses at least one communication protocol comprising of BACnet, LonWorks, OpenWay, OpenAMI, SmartGrid, ZigBee or AMI profile.

8. The system of claim 1, wherein the user module is capable of communicating directly with at least one of: utility meter, vehicle, computer, Personal Digital Assistant (PDA) and grid.

9. The system of claim 1, wherein the user module is capable of exchanging information with at least one utility company.

10. The system of claim 9, wherein the information comprises cost of electrical power, energy supply information, control information, status information and user notifications.

11. The system of claim 10, wherein the control information further comprises of type of the vehicle, battery capacity of the vehicle, generator size, fuel cell size, available fuel, available charge and operating mode of the vehicle.

12. The system of claim 11, wherein operating mode of the vehicle comprises of electrical power regulation mode and electrical power generation mode.

13. The system of claim 1, wherein the user module is capable of identifying the absolute geographical location of the vehicle.

14. The system of claim 13, wherein the absolute geographical location of the vehicle is identified using a Global Positioning System (GPS).

15. The system of claim 13, wherein the absolute geographical location of the vehicle is determined by extrapolating a relative geographical location with respect to a known geographical location.

16. The system of claim 15, wherein the known geographical location is determined by use of a utility meter.

17. The system of claim 1, wherein the user module is further connected to a fuel source.

18. The system of claim 1, wherein the user module further comprises:
(a) a bi-directional outlet type electrical interface;
(b) a processing unit;
(c) a sensor module;
(d) a control module;
(e) a memory module and
(f) power source.

19. The system of claim 18, wherein the bi-directional outlet type electrical interface is connected to a switch.

20. The system of claim 19, wherein the switch is integrated into a utility meter.

21. The system of claim 19, wherein the switch comprises of relay or circuit breaker.

22. The system of claim 19, wherein the switch is remotely controlled.

23. The system of claim 19, wherein the switch is locally controlled.

24. The system of claim 19, wherein the switch is capable of electrically isolating a building from the grid.

25. The system of claim 19, wherein the switch is capable of electrically isolating a vehicle from the grid.

26. The system of claim 18, wherein the bi-directional outlet type electrical interface is capable of connecting to the electrical wiring of a building.

27. The system of claim 26, wherein the connection between the bi-directional outlet type electrical interface and the electrical wiring of the building is hardwired.

28. The system of claim 26, wherein the connection between the bi-directional outlet type electrical interface and the electrical wiring of the building is through a standard 110 V/220V outlet.

29. The system of claim 18, wherein the bi-directional outlet type electrical interface is capable of receiving an electrical connection from the vehicle.

30. The system of claim 29, wherein the electrical connection from the vehicle is received through a standard 110 V/220 V outlet.

31. The system of claim 18, wherein the bi-directional outlet type interface is capable of determining the type of vehicle.

32. The system of claim 31, wherein the determination of vehicle type is carried out by at least one of the approaches comprising of load signature analysis, power factor measurement and RFID.

33. The system of claim 32, wherein load signature analysis further comprises of power factor analysis, current draw and harmonic analysis.

34. The system of claim 18, wherein the bi-directional outlet type electrical interface is capable of monitoring electrical parameters.

35. The system of claim 34, wherein the electrical parameters comprise of power in, power out, voltage, frequency and power factor.

36. The system of claim 18, wherein the processing unit further comprises a control logic.

37. A method for transferring electrical power between a grid and at least one vehicle, the method comprising:
(a) supplying electrical power to the vehicle;
(b) regulating the electrical power and
(c) acquiring electrical power from the vehicle.

38. The method of claim 37, wherein the step of supplying electrical power to the vehicle further comprises charging a battery of the vehicle.

39. The method of claim 37, wherein the step of acquiring electrical power from the vehicle further comprises discharging a battery of the vehicle.

40. The method of claim 37, wherein the vehicle is a Battery Electric Vehicle (BEV).

41. The method of claim 38, further comprising the step of maintaining a configurable minimum level of charge in the battery of the vehicle.

42. The method of claim 37, wherein the vehicle is a Plug-in Hybrid Electric Vehicle (PHEV).

43. The method of claim 37, wherein the vehicle is a Fuel Cell Vehicle (FCV).

44. The method of claim 37, wherein electrical power to the vehicle is supplied by an external fuel.

45. The method of claim 44, wherein the external fuel comprises of natural gas.

46. The method of claims 37, further comprising the step of maintaining a configurable minimum level of external fuel in the vehicle.

47. The method of claim 37, wherein the grid is a Smart Grid.

48. The method of claim 37, wherein the steps of:
(a) supplying electrical power to the vehicle and
(c) acquiring electrical power from the vehicle are performed to provided a definite number of kWh for a specified time period.

49. The method of claim 48, wherein the definite number of kWh are selected by a utility company.

50. The method of claim 48, wherein the specified time period is the peak electrical power usage period.

51. The method of claim 37, wherein the steps of:
(a) supplying electrical power to the vehicle;
(b) regulating the electrical power and
(c) acquiring electrical power from the vehicle are controlled by a control logic.

52. The method of claim 51, wherein the control logic is integrated into a processing unit.

53. The method of claim 51, wherein the control logic is capable of entering into an idling mode.

54. The method of claim 51, wherein the control logic is capable of entering into a debugging mode.

55. The method of claim 51, wherein the control logic performs the step of
(b) regulating the electrical power when the vehicle is connected to the grid.

56. The method of claim 51, wherein the control logic performs the step of
(b) regulating the electrical power
when the Area Control Error (ACE) exceeds a predefined range.

57. The method of claim 56, wherein the predefined range is set by a user.

58. The method of claim 56, wherein the predefined range is set by a utility company.

59. The method of claim 51, wherein the control logic performs the step of
(b) regulating the electrical power for a definite time period.

60. The method of claim 59, wherein the definite time period is set by a utility company.

61. The method of claim 51, wherein the control logic performs the step of
(c) acquiring electrical power from the vehicle upon occurrence of a brownout event.

62. The method of claim 51, wherein the control logic performs the step of
(c) acquiring electrical power from the vehicle upon occurrence of a blackout event.

63. The method of claim 51, wherein the control logic performs the step of
(c) acquiring electrical power from the vehicle when cost of acquiring electrical power from the vehicle is less than cost of acquiring electrical power from the grid.

64. The method of claim 63, wherein the cost of acquiring electrical power from the vehicle includes cost of supplying electrical power to the vehicle and fatigue cost.

65. The method of claim 37, wherein the steps of
(a) supplying electrical power to the vehicle;
(b) regulating the electrical power and
(c) acquiring electrical power from the vehicle are compensated by a utility company.

66. The method of claim 37, wherein the steps of
(a) supplying electrical power to the vehicle;
(b) regulating the electrical power and
(c) acquiring electrical power from the vehicle are performed cyclically.
